(19) United States
(12) Patent Application Publication
(10) Pub. No.: US 2024/0141955 A1
(43) Pub. Date: May 2, 2024

(54) BEARING AND SEALING DEVICE

(71) Applicant: Schaeffler Technologies AG & Co. KG, Herzogenaurach (DE)

(72) Inventors: Xin LIU, Shanghai (CN); Lijuan WU, Suzhou (CN); Jianchang ZHANG, Shanghai (CN); Aoran QIN, Shanghai (CN); Ding LI, Suzhou (CN)

(73) Assignee: Schaeffler Technologies AG & Co. KG, Herzogenaurach (DE)

(21) Appl. No.: 18/272,146

(22) PCT Filed: Jan. 8, 2022
(86) PCT No.: PCT/CN2022/072600

§ 371 Date: Jul. 13, 2023

(30) Foreign Application Priority Data
Jan. 18, 2021 (CN) 202110062533.2

(51) Int. Cl. F16C 33/78; F16C 33/74

(52) U.S. Cl. CPC F16C 33/782; F16C 33/74

(57) ABSTRACT

A bearing and a sealing device. The sealing device includes: a skeleton; and a sealing part, which, taken as a whole, is of an annular structure, the sealing part comprising an elastic part and a plastic part, and the elastic part being fixed to the skeleton. After the sealing device is arranged between a bearing inner ring and a bearing outer ring, the plastic part and the bearing inner ring form contact sealing, the elastic part and the plastic part are relatively fixed, and in the radial direction, at least part of the plastic part is arranged between the bearing inner ring and the elastic part. The coefficient of friction of the material of the plastic part is smaller than the coefficient of friction of the material of the elastic part.

### CROSS-REFERENCE TO RELATED APPLICATIONS

This application is the U.S. National Phase of PCT Appln. No. PCT/CN2022/072600, filed Dec. 18, 2022, which claims priority from Chinese Patent Application No. 202110062533.2, filed Jan. 18, 2021, the entire disclosures of which are incorporated by reference herein.

### TECHNICAL FIELD

The present disclosure relates to the technical field of bearing seals, in particular to a bearing and a sealing device.

### BACKGROUND

An Articulated robot, also known as articulated arm robot or articulated mechanical arm, is one of the most common forms of industrial robot in industrial today, and is suitable for mechanical automation operations in various industrial fields. An articulated arm bearing plays a decisive role in the bearing capacity, dynamic performance, and accuracy of the robot.

The articulated arm bearing includes an inner ring, an outer ring and a sealing ring arranged between the inner ring and the outer ring. The sealing ring is used to prevent oil from leaking. Since the articulated arm of the robot needs to repeatedly achieve the rocker action of grasping and retracting, it is necessary to frequently switch a rotation direction of the bearing, increasing the risk of leakage of lubricating grease.

Therefore, the sealing performance of the articulated arm bearing needs to be improved.

### SUMMARY

The technical problem to be solved is to provide a bearing and a sealing device which improves the sealing performance of the bearing.

In order to solve the above problem, embodiments of the present disclosure provide a bearing suitable for being arranged between a bearing inner ring and a bearing outer ring. The sealing device includes a frame and a sealing portion. An overall structure of the sealing portion is annular. The sealing portion includes an elastic portion and a plastic portion. The elastic portion is fixed to the frame. After the sealing device is arranged between the bearing inner ring and the bearing outer ring, the plastic portion and the bearing inner ring form contact sealing, the elastic portion is fixed relative to the plastic portion, and at least part of the plastic portion is arranged between the bearing inner ring and the elastic portion in a radial direction. A friction coefficient of the plastic portion is smaller than a friction coefficient of the elastic portion.

Correspondingly, the present disclosure further provides a bearing which includes a bearing inner ring, a bearing outer ring and the above sealing device arranged between the bearing inner ring and the bearing outer ring.

Compared with the prior art, the technical solution of the present disclosure has the following advantages: in the sealing device according to the embodiments of the present disclosure, after the sealing device is arranged between the bearing inner ring and the bearing outer ring, the plastic portion and the bearing inner ring form contact sealing, the elastic portion is fixed relative to the plastic portion, and at least part of the plastic portion is arranged between the bearing inner ring and the elastic portion in the radial direction. During the operation of the bearing, relative rotation occurs between the plastic portion and the bearing inner ring. Since the friction coefficient of the plastic portion is smaller than the friction coefficient of the elastic portion, friction between the plastic portion and the bearing inner ring is smaller than friction between the elastic portion and the bearing inner ring, and a surface, in contact with the bearing inner ring, of the plastic portion is not easy to wrinkle. Therefore, even if the bearing suddenly changes its rotation direction, and the grease fails to change with the rotation direction in time, the phenomenon whereby the grease moves axially due to the pumping action of the wrinkles does not occur, which can suppress the grease leakage between the bearing inner ring and the plastic portion when the bearing inner ring suddenly changes the rotation direction, and thus improve the sealing effect of the sealing device. Moreover, the friction between the plastic portion and the bearing inner ring is reduced, which can further prolong the service life of the sealing device.

An overall structure of the plastic portion is annular. The plastic portion includes an outer ring fixed end and an inner ring free end which are fixedly connected. The outer ring fixed end is fixed to an axial outer end surface of the frame. After the sealing device is arranged between the bearing inner ring and the bearing outer ring, the inner ring free end is bendable along an axial direction of the sealing device and is arranged between the bearing inner ring and the elastic portion in the radial direction, and the elastic portion is fixed relative to the inner ring free end. By fixing the plastic portion to the frame, the firmness is improved, the plastic portion is prevented from moving axially, and it is ensured that the end face of the plastic portion is parallel to the axial end surfaces of other components of the bearing (the bearing inner ring and the bearing outer ring). After mounting, the inner ring free end is bendable along the axial direction of the sealing device and is arranged between the bearing inner ring and the elastic portion in the radial direction, which can increase the contact area between the plastic portion and the bearing inner ring and provide space for subsequently defining an annular groove at the inner ring free end.

### BRIEF DESCRIPTION OF THE DRAWINGS

FIG. 1 and FIG. 2 are schematic views showing an interaction between a sealing device and a bearing inner ring in different rotation directions.

FIG. 3 is a schematic structural view of the sealing device according to an embodiment of the present disclosure.

FIG. 4 is another schematic structural view of the sealing device according to an embodiment of the present disclosure.

FIG. 5 is a schematic view showing a mounting state of FIG. 4.

FIG. 6 is another schematic structural view of the sealing device according to an embodiment of the present disclosure.

FIG. 7 is a schematic structural view of a bearing according to an embodiment of the present disclosure.

### DETAILED DESCRIPTION

According to the background technology, the sealing performance of the articulated arm bearing needs to be improved.

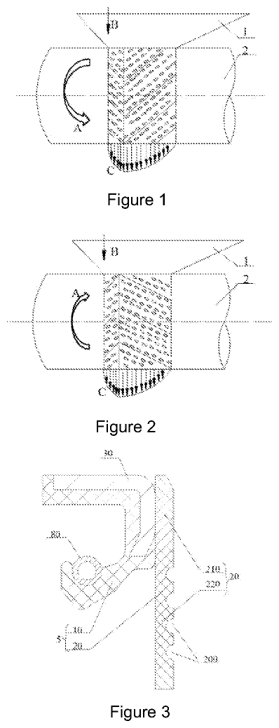

The reasons for poor sealing performance of the bearing are analyzed with reference to FIG. 1 and FIG. 2 below.

FIG. 1 and FIG. 2 are schematic views showing an interaction between a sealing device and a bearing inner ring in different rotation directions.

The sealing device generally includes a frame, a rubber component bonded to the frame, and a rubber sealing lip 1 which is in contact with a bearing inner ring 2. The sealing device is arranged between the bearing inner ring 2 and a bearing outer ring, and contact sealing is formed between the sealing lip 1 and the bearing inner ring 2. Taking the bearing mounted on the mechanical arm as an example, since the mechanical arm needs to achieve the rocker action of grasping and retracting, the bearing needs to rotate slowly in two directions at a low speed, generally less than 30 rpm, and the rotation direction is frequently switched. As shown in FIG. 1, the hollow arrow A represents the rotation direction of the bearing, and the solid arrow B above the sealing lip 1 represents the radial force (the force that causes the sealing lip 1 to abut against the bearing inner ring 2). When the bearing rotates, grease rotates following the bearing inner ring. Due to the friction between the sealing lip 1 and the bearing inner ring 2, the sealing lip 1 is stretched and deformed along the bearing inner ring 2 to form wrinkles (as shown by the wavy broken lines in FIG. 1), and the wrinkles can pump the grease on the sealing lip 1 back to an inner side of the bearing (i.e. a left side in FIG. 1). The dense arrows C below the bearing inner ring 2 represent the pressure distribution diagram, and the pressure distribution is determined by the shape of the wrinkles in the figure. As shown in FIG. 2, when the rotation direction is suddenly switched, the rotation direction of the bearing inner ring 2 (the direction of the hollow arrow A) is changed immediately, and the wavy direction of the wrinkles, in contact with the bearing inner ring 2, on the sealing lip 1 is correspondingly switched. However, due to the low rotation speed, the moving direction of grease cannot be changed in a short time. When the grease encounters the wrinkles with changed directions (as shown by the wavy broken lines in FIG. 2), the grease moves toward an outer side of the bearing (i.e. a right side in FIG. 2) under the pumping action of the wrinkles, so the grease is prone to leakage.

In order to improve the sealing performance of the articulated arm bearing, a sealing device is provided according to the embodiments of the present disclosure. During the operation of the bearing, relative rotation occurs between the plastic portion and the bearing inner ring. Since the friction coefficient of the plastic portion is smaller than the friction coefficient of the elastic portion, the friction between the plastic portion and the bearing inner ring is smaller than the friction between the elastic portion and the bearing inner ring, and the surface, in contact with the bearing inner ring, of the plastic portion is not easy to wrinkle. Therefore, even if the bearing suddenly changes its rotation direction, and the grease fails to change with the rotation direction in time, the phenomenon whereby the grease moves axially due to the pumping action of the wrinkles does not occur, which can suppress the grease leakage between the bearing inner ring and the plastic portion when the bearing inner ring suddenly changes the rotation direction, and thus improve the sealing effect of the sealing device. Moreover, the friction between the plastic portion and the bearing inner ring is reduced, which can further prolong the service life of the sealing device.

Technical solutions in the embodiments of the present invention are clearly and completely described hereinafter in conjunction with the drawings in the embodiments of the present disclosure. Apparently, the embodiments described in the following are only some embodiments of the present disclosure, rather than all embodiments. Based on the embodiments in the present disclosure, all of other embodiments, made by the person skilled in the art without any creative efforts, fall into the scope of protection of the present disclosure.

It should be noted that, unless otherwise specified, axial direction, radial direction and circumferential direction refer to the axial direction, radial direction and circumferential direction of the sealing device, respectively. An axial outer end refers to the right side in FIG. 3 to FIG. 7, and an axial inner end refers to the left side in FIG. 3 to FIG. 7. A radial outer side refers to the side away from a central axis of the sealing device in the radial direction (an upper side in FIG. 3 to FIG. 7), and a radial inner side refers to the side close to the central axis of the sealing device in the radial direction (a lower side in FIG. 3 to FIG. 7).

Embodiments of the present disclosure provide a sealing device suitable for being arranged between a bearing inner ring and a bearing outer ring. The sealing device includes:
a frame; and
a sealing portion. An overall structure of the sealing portion is annular. The sealing portion includes an elastic portion and a plastic portion. The elastic portion is fixed to the frame. After the sealing device is arranged between the bearing inner ring and the bearing outer ring, the plastic portion and the bearing inner ring form contact sealing, the elastic portion is fixed relative to the plastic portion, and at least part of the plastic portion is arranged between the bearing inner ring and the elastic portion in a radial direction. A friction coefficient of the plastic portion is smaller than a friction coefficient of the elastic portion.

It should be noted that, the elastic portion is fixed relative to the plastic portion, which means that the elastic portion is stationary relative to the plastic portion during the operation of the sealing device. Therefore, before the sealing device is arranged between the bearing inner ring and the bearing outer ring, the elastic portion and the plastic portion can be directly fixed together or not in contact, as long as the elastic portion is fixed relative to the plastic portion after the sealing device is arranged between the bearing inner ring and the bearing outer ring. For example, in an embodiment, the elastic portion and the plastic portion may be directly bonded together, and the plastic portion is arranged between the bearing inner ring and the elastic portion in the radial direction. In another embodiment, the elastic portion and the plastic portion may be two separate components, and the elastic portion abuts against the plastic portion with the help of other external forces (such as spring force) after the plastic portion is mounted to the bearing inner ring, so as to achieve the fixation of the elastic portion relative to the plastic portion. Alternatively, in another embodiment, both the elastic portion and the plastic portion may be fixed to the frame, so as to achieve the fixation of the elastic portion relative to the plastic portion.

In particular, referring to FIG. 3, FIG. 3 is a partially schematic view of the sealing device according to an embodiment of the present disclosure. It can be understood by those skilled in the art that only a partially cross-sectional view of the sealing device is shown in FIG. 3.

As shown in FIG. 3, in a specific embodiment, an overall structure of the plastic portion 20 is annular, and includes an outer ring fixed end 210 and an inner ring free end 220 which are fixedly connected. The outer ring fixed end 210 is fixed to an axial outer end surface of the frame 30. After the sealing device is arranged between the bearing inner ring and the bearing outer ring, the inner ring free end 220 is bendable along an axial direction of the sealing device (cf. FIG. 5) and is arranged between the bearing inner ring and the elastic portion 10 in the radial direction, and the elastic portion 10 is fixed relative to the inner ring free end 220. By fixing the plastic portion 20 to the frame 30, the firmness is improved, the plastic portion 20 is prevented from moving axially, and it is ensured that the end face of the plastic portion 20 is parallel to the end surfaces of other components of the bearing (the bearing inner ring and the bearing outer ring 40). After mounting, the inner ring free end 220 is bendable along the axial direction of the sealing device and is arranged between the bearing inner ring and the elastic portion 10 in the radial direction, which can increase the contact area between the plastic portion 20 and the bearing inner ring and provide space for subsequently defining an annular groove 200 at the inner ring free end 220.

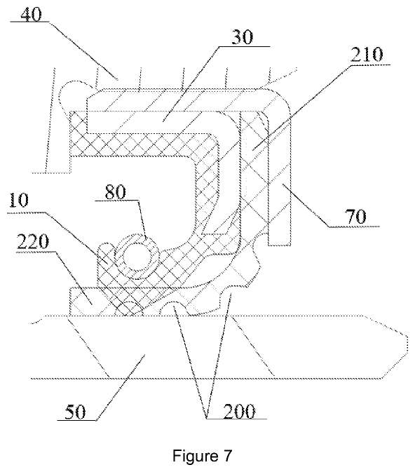

In order to improve the contact force between the inner ring free end 220 and the bearing inner ring, the sealing device may further include a spring 80 an overall structure of which is annular. The spring is sleeved on an outer ring surface of the elastic portion 10 and is arranged in a cross section where the elastic portion 10, the plastic portion 20 and the bearing inner ring all lie. Taking FIG. 7 as an example, the spring 80 is arranged on the cross section where the elastic portion 10, the inner ring free end 220 and the bearing inner ring 50 all lie.

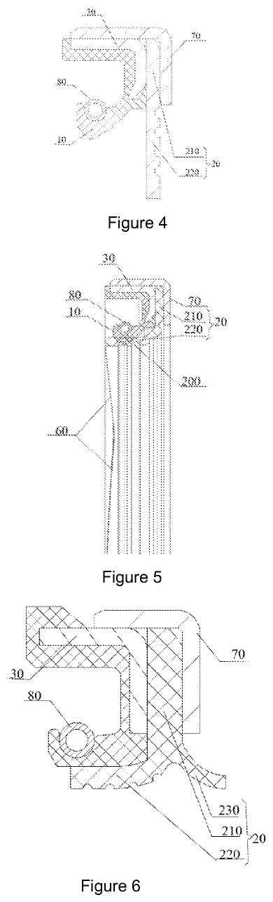

Referring to FIG. 4 and FIG. 5, during mounting, the plastic portion 20 is first bent as shown in FIG. 5 with the help of a mounting tool, and then the mounting tool is pulled out, so that the inner ring free end 220 of the plastic portion 20 is in close contact with the bearing inner ring 50 (as shown in FIG. 7). At the same time, the contact force between the plastic portion 20 and the bearing inner ring is improved by the elastic portion 10 mounted with the loading spring 80 abutting against the plastic portion 20.

A friction coefficient of the plastic portion 20 is smaller than a friction coefficient of the elastic portion 10. Specifically, the plastic portion 20 is made of polytetrafluoroethylene (PTFE). The friction coefficient of PTFE is extremely low, which can greatly reduce the friction torque of the sealing device, reduce the wear of the plastic portion 20, and improve the service life of the sealing device. Alternatively, in other embodiments, the plastic portion may be made of other materials with a low friction coefficient, so as to reduce the possibility of deformation of the plastic portion at the connection with the bearing inner ring due to friction, thereby improving the sealing performance of the sealing device.

In the sealing device according to the embodiments of the present disclosure, after the sealing device is arranged between the bearing inner ring and the bearing outer ring, the plastic portion and the bearing inner ring form contact sealing, the elastic portion is fixed relative to the plastic portion, and at least part of the plastic portion is arranged between the bearing inner ring and the elastic portion in the radial direction. During the operation of the bearing, relative rotation occurs between the plastic portion and the bearing inner ring. Since the friction coefficient of the plastic portion is smaller than the friction coefficient of the elastic portion, a friction between the plastic portion and the bearing inner ring is smaller than a friction between the elastic portion and the bearing inner ring, and a surface, in contact with the bearing inner ring, of the plastic portion is not easy to wrinkle. Therefore, even if the bearing suddenly changes its rotation direction, and the grease fails to change with the rotation direction in time, the phenomenon that the grease moves axially due to the pumping action of the wrinkles does not occur, which can suppress the grease leakage between the bearing inner ring and the plastic portion when the bearing inner ring suddenly changes the rotation direction, and thus improve the sealing effect of the sealing device. Moreover, the friction between the plastic portion and the bearing inner ring is reduced, which can further prolong the service life of the sealing device.

Referring to FIG. 3, in a specific embodiment, an annular groove 200 is defined at the inner ring free end 220. When the inner ring free end 220 is arranged between the bearing inner ring and the bearing outer ring 40, an opening of the annular groove 200 faces towards the bearing inner ring. Once there is a small amount of grease flowing outward in the axial direction, the grease may be retained in the annular groove 200 and will not flow further outward in the axial direction, thereby further improving the sealing effect of the sealing device.

A shape of the annular groove 200 is not limited, and the number of the annular groove 200 may be one or at least two.

Referring to FIG. 4 and FIG. 5, in order to enhance the fixation effect of the plastic portion 20, in a specific embodiment, the sealing device further includes a stop ring 70 fixed to the frame 30. The stop ring 70 and the frame 30 are respectively arranged at two axial ends of the plastic portion 20. While the sealing device is mounted on the bearing inner ring, during the axial bending of the inner ring free end 220 of the plastic portion, the outer ring fixed end 210 of the plastic portion is limited in an axial area defined by the frame 30 and the stop ring 70, which can prevent the outer ring fixed end 210 from falling off from the frame 30 due to the tendency of moving axially away from the frame 30.

Specifically, the stop ring 70 may include an axial portion and a radial portion which are fixedly connected. The radial portion of the stop ring 70 is in an interference fit with the frame 30, the plastic portion 20 is located between the axial portion and the frame 30, the axial portion of the stop ring 70 is in an interference fit with the plastic portion 20, and the plastic portion 20 may be directly bonded between the frame 30 and the stop ring 70. Alternatively, in other embodiments, in order to reduce costs, the sealing device may not include a stop ring, and an outer ring fixed end surface of the plastic portion is directly bonded to an outer end surface of the radial portion of the frame.

Referring to FIG. 5, in a specific embodiment, the plastic portion 20 further includes thrust surfaces 60. The thrust surfaces 60 are located at an axial inner end of the plastic portion 20 when the plastic portion 20 and the bearing inner ring form contact sealing.

It is easy to be understood that the thrust surfaces are slope surfaces, that is, the thrust surfaces are not perpendicular to a direction of an axis, but form an included angle (not a right angle) with the axis. Taking FIG. 5 as an example, the grease is located on the left side of FIG. 5. When the grease accumulates at the inner ring free end 220 of the plastic portion 20, the thrust surfaces as inclined surfaces can block the grease, and the thrust surfaces 60 are beneficial to preventing the grease from further flowing towards the axial outer end.

Further, referring to FIG. 5, under the working condition that the bearing needs to rotate slowly in two directions, the thrust surfaces 60 are evenly distributed along a circumferential direction of the plastic portion 20 and slope surface directions of adjacent thrust surfaces 60 are symmetrical about an intersection line of the adjacent thrust surfaces 60. Therefore, no matter whether the bearing rotates forward or backward, there always exist the thrust surfaces 60 playing the role of pushing the grease back to the axial inner end to prevent the grease from further flowing toward the axial outer end.

Referring to FIG. 6, in a specific embodiment, the plastic portion 20 further includes:
a dust-proof lip 230 fixed to an axial outer end surface of the annular fixed end. When the inner ring free end 220 is arranged between the bearing inner ring and the bearing outer ring 40, the dust-proof lip 230 extends in a direction axially away from the inner ring free end 220 and radially close to the bearing inner ring. Since the dust-proof lip 230 is arranged at the axial outer end, the dust-proof lip 230 can block dust and a small amount of splashing water, thereby further improving the sealing effect of the sealing device.

Referring to FIG. 7, in order to solve the above problem, a bearing is further provided according to an embodiment of the present disclosure, which includes a bearing inner ring 50, a bearing outer ring 40 and the above sealing device. The sealing device is arranged between the bearing inner ring and the bearing outer ring 50.

During the operation of the bearing, relative rotation occurs between the plastic portion and the bearing inner ring. Since the friction coefficient of the plastic portion is smaller than the friction coefficient of the elastic portion, the friction between the plastic portion and the bearing inner ring is smaller than the friction between the elastic portion and the bearing inner ring, and the surface, in contact with the bearing inner ring, of the plastic portion is not easy to wrinkle. Therefore, even if the bearing suddenly changes its rotation direction, and the grease fails to change with the rotation direction in time, the phenomenon whereby the grease moves axially due to the pumping action of the wrinkles does not occur, which can suppress the grease leakage between the bearing inner ring and the plastic portion when the bearing inner ring suddenly changes the rotation direction, and thus improve the sealing effect of the bearing. Moreover, the friction between the plastic portion and the bearing inner ring is reduced, which can further prolong the service life of the bearing.

Although the embodiments of the present disclosure are disclosed as above, the present disclosure is not limited thereto. Any person skilled in the art can make various changes and modifications without departing from the spirit and scope of the present disclosure. Therefore, the scope of protection of the present disclosure should be subject to the scope defined by the claims.

1. A sealing device, suitable for being arranged between a bearing inner ring and a bearing outer ring, the sealing device comprising:
a frame; and
a sealing portion, which is annular, the sealing portion comprises an elastic portion and a plastic portion, the elastic portion is fixed to the frame, the plastic portion is adapted to form a contact seal with the bearing inner ring after arrangement of the sealing device between the bearing inner ring and the bearing outer ring, the elastic portion is fixed relative to the plastic portion, and at least part of the plastic portion is adapted to be arranged between the bearing inner ring and the elastic portion in a radial direction, and a friction coefficient of the plastic portion is smaller than a friction coefficient of the elastic portion.

2. The sealing device according to claim 1, wherein the plastic portion is annular, the plastic portion comprises an outer ring fixed end and an inner ring free end which are fixedly connected, the outer ring fixed end is fixed to an axial outer end surface of the frame, and the inner ring free end is bendable along an axial direction of the sealing device and is adapted to be arranged between the bearing inner ring and the elastic portion in the radial direction, and the elastic portion is fixed relative to the inner ring free end.

3. The sealing device according to claim 2, wherein an annular groove is defined at the inner ring free end, and an opening of the annular groove is adapted to face towards the bearing inner ring when the inner ring free end is arranged between the bearing inner ring and the bearing outer ring.

4. The sealing device according to claim 2, further comprising:
a stop ring fixed to the frame, and the stop ring and the frame are respectively arranged at two axial ends of the plastic portion.

5. The sealing device according to claim 3, wherein the plastic portion further comprises thrust surfaces, and the thrust surfaces are adapted to be located at an axial inner end of the plastic portion when the plastic portion and the bearing inner ring form contact sealing.

6. The sealing device according to claim 5, wherein the thrust surfaces are evenly distributed along a circumferential direction of the plastic portion, and slope surface directions of adjacent ones of the thrust surfaces are symmetrical about an intersection line of the adjacent ones of the thrust surfaces.

7. The sealing device according to claim 1, wherein the plastic portion is made of polytetrafluoroethylene.

8. The sealing device according to claim 2, further comprising:
a dust-proof lip fixed to an axial outer end surface of the annular fixed end, and the dust-proof lip extends in a direction axially away from the inner ring free end and is adapted to be radially close to the bearing inner ring when the inner ring free end is arranged between the bearing inner ring and the bearing outer ring.

9. The sealing device according to claim 1, further comprising:
an annular spring sleeved on an outer ring surface of the elastic portion and arranged in a cross section where the elastic portion, the plastic portion and the bearing inner ring all lie.

10. A bearing, comprising a bearing inner ring, a bearing outer ring and the sealing device according to claim 1, wherein the sealing device is arranged between the bearing inner ring and the bearing outer ring.

11. A bearing comprising:
an inner ring;
an outer ring; and
a sealing device arranged between the inner ring and the outer ring, the sealing device comprising:
a frame, and
a sealing portion including an elastic portion and a plastic portion, the elastic portion is fixed to the frame, the plastic portion forms a contact seal with the bearing inner ring, the elastic portion is fixed relative to the plastic portion, and at least part of the plastic portion is arranged between the bearing inner ring and the elastic portion in a radial direction, and a friction coefficient of the plastic portion is smaller than a friction coefficient of the elastic portion.

12. The bearing according to claim 11, wherein the plastic portion is annular, the plastic portion comprises an outer ring fixed end and an inner ring free end which are fixedly connected, the outer ring fixed end is fixed to an axial outer end surface of the frame, and the inner ring free end is bendable along an axial direction of the sealing device and is arranged between the bearing inner ring and the elastic portion in the radial direction, and the elastic portion is fixed relative to the inner ring free end.

13. The bearing according to claim 12, wherein an annular groove is defined at the inner ring free end, and an opening of the annular groove faces towards the bearing inner ring.

14. The bearing according to claim 13, wherein the plastic portion further comprises thrust surfaces, and the thrust surfaces are located at an axial inner end of the plastic portion.

15. The bearing according to claim 14, wherein the thrust surfaces are evenly distributed along a circumferential direction of the plastic portion, and slope surface directions of adjacent ones of the thrust surfaces are symmetrical about an intersection line of the adjacent ones of the thrust surfaces.

16. The bearing according to claim 12, further comprising:
a stop ring fixed to the frame, and the stop ring and the frame are respectively arranged at two axial ends of the plastic portion.

17. The bearing according to claim 12, further comprising:
a dust-proof lip fixed to an axial outer end surface of the annular fixed end, and the dust-proof lip extends in a direction axially away from the inner ring free end and is radially adjacent to the bearing inner ring.

18. The bearing according to claim 11, wherein the plastic portion is made of polytetrafluoroethylene.

19. The bearing according to claim 11, further comprising:
an annular spring sleeved on an outer ring surface of the elastic portion and arranged in a cross section where the elastic portion, the plastic portion and the bearing inner ring all lie.
